(19) United States
(12) Patent Application Publication
(10) Pub. No.: US 2004/0199494 A1
(43) Pub. Date: Oct. 7, 2004

(54) Method and apparatus for tagging and locating audio data

(76) Inventor: Nikhil Bhatt, Cupertino, CA (US)

Correspondence Address: THE HECKER LAW GROUP, 1925 CENTURY PARK EAST, SUITE 2300, LOS ANGELES, CA, 90067, US

(21) Appl. No.: 10/407,853

(22) Filed: Apr. 4, 2003

(51) Int. Cl. G06F 7/00

(52) U.S. Cl. 707/3

(57) ABSTRACT

A method for indexing audio files to provide a small number of good matches from a search engine is presented. An indexer parses the audio files and generates search keywords which are presented to a user via a graphical user interface. The keywords presented to the user are only those keywords that matched tags obtained from the audio files that were indexed. Thus, the user is never presented information that will not provide a valid search. The user's search query is simply a selection of one of the keywords presented by the indexer. The user can further narrow the search results to audio files that are within a predetermined number of semitones of the project tone. Thus, users need not waste time listening to audio files that are completely out of tone with their projects when search for a particular audio file.

### FIELD OF THE INVENTION

This invention relates to the field of data processing. More specifically, this invention is directed to a method and apparatus for tagging and locating audio data.

### BACKGROUND OF THE INVENTION

Software programs exist that enable users to create songs and other audio files by seamlessly combining a set of pre-recorded audio files. An example of a prior art program that has such functionality is called ACID™ (distributed by Sound Foundry™, Incorporated). Users of ACID™ and other sound editing programs have a need to locate one or more pre-recorded audio files (also called loops). One way to locate these pre-recorded audio files is to use a search engine.

The term search engine refers to any computer system configured to locate data in response to a query for that data. Search engines may, for instance, provide users with a mechanism for retrieving data stored in places such as the World-Wide-Web (WWW), storage devices such as Compact Discs (CD), hard drives, or data stored on any other type of data storage location. Users typically formulate the query for information and view the results of any search performed in response to the user's request via a Graphical User Interface. Since the query is what defines the scope of data the search engine will return, it is important the query be carefully constructed. If the user enters an overly broad query the set of results the search engine returns is too large and therefore of little use to the user. To get a tightly constrained set of results (i.e., return a small number of good matches) the users must construct a query that narrowly defines the data the user is attempting to locate. Once the user constructs and submits such a query, that query is then used to traverse an index of available information built by the search engine. One problem with this prior art approach is that it requires users to have significant expertise in forming search queries. If users lack this expertise, the user is forced to use a process of trial and error to form a query that obtains a desired result. Since most computer users do not have intimate knowledge of the best way to formulate a particular query, search results are generally numerous requiring the user to view multiple results to locate the result that was actually desired.

When a search engine is used to find audio data (e.g., AIFF, WAV, MP3, etc . . . ) users enter a query that defines the type of audio files the user is attempting to locate. For instance, if a user were trying to locate an audio file that contained a Jamaican drum beat, the user might build a query that looks for the words “Jamaica” and “drums.” Prior art search engines utilize this query information to search for these keywords. If the file containing the data the user is attempting to locate is named “track0001.wav”, the system would be unable to locate the file based on the information provided by the user. If the file is stored in a directory named “c:MyMusicJamaica” the system may have the ability to locate all of the files stored in that directory, but could not limit the results to drum music only. If the user inputs a more general query (e.g., *.wav”, the system can locate the “track0001.wav file, but will also locate every other WAV file on the system. To create a query that returns the audio data the user is looking for, users must have specific knowledge as to how files on the system are named and what directory organization is used. However, in the large majority of cases users do not have such specific knowledge and are therefore left to manually browse through and listen to various audio files to locate the desired file.

Browsing for files in this way is adequate if there is a limited set of audio files to examine. For example, to locate an acoustic base track, a user might browse through a directory that contains a limited number of base tracks (e.g., a directory that has a file named “acoustic base”). Thus, prior art methods are sufficient when the project creator is looking through a limited data set. However, such working parameters are not realistic. Most project creators have archives containing a significant number of audio files. These audio files, also termed “loops”, are typically stored in directories that classify the type of data within that directory. Loops that relate to “acoustic base”, for instance might be stored in a directory titled “Base”. Some projects may have several gigabytes of loops on a disk spread over several directories with similar or non-similar names and network computers. When data is organized in this way, it is challenging for users to find a desired loop (e.g., guitar) because of the way search engines look for audio data. Users are often forced to listening to possibly hundreds of irrelevant loops just to locate one loop. This disclosure uses the terms loop and audio file interchangeably.

Users can purchase libraries of loop files on CD or some other data source. These libraries are typically organized into a set of directories and sub-directories. For instance, the loop files may be stored in a set of sub-directories organized by instruments, e.g., turntables, piano, flutes, etc. Within each sub-directory may be other sub-directories. Thus a user may spend a lot of time browsing the disk to locate a particular sound. That is just one CD's worth. Usually there are multiple CDs of loops available to a music creator. If, for simplicity, every single CD is organized in the same fashion described above, then there would be multiple directories containing the same basic instrument that a user would have to traverse. For example, a user looking for guitars may have loop directories CD-1/guitars/electric/etc, CD-2/guitars . . . and CD-N/guitars. Therefore, a user wanting to find a particular guitar may have to review every CD to find the desired note. This is a cumbersome and undesirable process.

Therefore, there is a need for a search engine that enables music creators to locate a small number of useful audio files. This would save users the time and hassle associated with the prior art techniques discussed above.

### BRIEF DESCRIPTION OF DRAWINGS

FIG. 1 is a sample user interface for assigning tags and descriptors to a sound file.

FIG. 2 is an illustration of assignment of a musical key property tag to a sound file.

FIG. 3 is an illustration of selection and assignment of a scale type to a musical key property tag of a sound file.

FIG. 4 is an illustration of selection and assignment of time signature to a sound file.

FIG. 5 is an illustration of all the assigned property tags of a sound file.

FIG. 6 is an illustration of assignment of musical genre to a sound file.

FIG. 7 is an illustration of assignment of instrumentation search tags to a sound file.

FIG. 8 is an illustration of assignment and selection of descriptors for a sound file.

FIG. 9 is an illustration of a user interface for indexing audio files.

FIG. 10 is an illustration of indexing in accordance with an embodiment of the present invention.

FIG. 11 is an illustration of a column view search engine interface in accordance with an embodiment of the present invention.

FIG. 12 is an illustration of a button view search engine interface in accordance with an embodiment of the present invention.

### SUMMARY OF INVENTION

The invention comprises a method and apparatus for tagging and locating audio data. One embodiment of the invention utilizes a tagging technique to build an index that associates a set of audio files with a number of musically distinct classifications. When queried, a search engine utilizes this index to locate audio files that fall within the parameters of the query. So that the results returned by the search engine contain a limited number of useful matches, embodiments of the invention utilize a query building tool that is tightly coupled with the index. The query building tool constrains user inputs to match the classifications stored within the index. By effectively managing the inputs, the search engine described herein is able to return a better set of results than existing search engines.

The first step in building the index mentioned above and described in detail herein is to associate each audio file with a set of tags descriptive of the file itself. For instance, an audio file distributor (a user, creator, etc . . . ) may assign audio files a set of tags that convey information about the file. Some examples of the type of information embedded into these tags include aspects of an audio file such as its musical key, time signature, or musical scale. The user or creator may also insert information such as an audio file's musical genre or instrumentation type into these tags. In addition, users may assign descriptors that provide any other generally desirable information about an audio file. For instance, a user may utilize tags that define the mood the audio file conveys or whether or not the audio file is a single instrument or an ensemble. In one implementation of the invention, the tags are appended to the audio file in a way that does not distort the audio content, but still maintains compatibility with prior art systems. The more comprehensive the tag information is, the higher the likelihood the search engine will provide a small number of good matches.

One or more embodiments of the invention utilize an indexer to parse the tagged audio files and generate a set of search keywords. These keywords are presented to the user via a graphical user interface that implements the query building tool. The keywords presented to the user are from the set of keywords in the tags of the audio files. Thus, the user is presented with a constrained set of keywords that will provide a valid (and helpful) search result.

In one or more embodiments, the user's search query is simply a selection of one of the keywords presented by the indexer. The user can further narrow the search result to audio files within a predetermined number of semitones of the project tone. Thus, users need not waste time listening to loops that are completely out of tone with their projects.

### DETAILED DESCRIPTION

The invention comprises a method and apparatus for tagging and locating audio data. Systems implementing the invention utilize a search engine to locate audio files relevant to a particular query. In the following description, numerous specific details are set forth to provide a more thorough description of the present invention. It will be apparent, however, to one skilled in the art, that the present invention may be practiced without these specific details. In other instances, well known features have not been described in detail so as not to obscure the present invention. The claims, however, are what define the meets and bounds of the invention.

The search engine described herein is adapted in at least one instance to locate audio files, but the concepts and ideas conveyed herein are applicable to locating other types of data files. When the invention is applied to software programs configured to assist users with the process of creating music (e.g., by using a set of pre-recorded audio files), the system is adapted to allow the user to enter music specific queries. These music specific queries are built using a constrained set of keywords that is tightly coupled with the audio data the user is attempting to locate. Users can, for example enter or select from known keywords to search for specific audio files. Readers should note, however, that the following description uses music applications for purposes of example only. It will be apparent to those of skill in the art that methods of this invention are applicable to other applications as well.

The search engine configured in accordance with one embodiment of the invention is designed to locate a type of audio file referred to as a “loop.” Loops are music segments that seamlessly merge at the beginning and end of the file so that during playback the file can be repeated numerous times with hitting an end point. Embodiments of the present invention implement a mechanism for enabling users to locate audio files such as loop files without knowing the name of the file itself or having to manually play the file. In prior art systems users that are, for example, looking for an audio file that contains rhythmic guitar music may have to listen to many different rhythmic guitar loops in order to identify the appropriate loop for their application. The invention enables such users to locate what they are looking for without requiring the user to engage in an extensive trial and error process for purposes of determining an appropriate set of keywords. For instance, a user looking for rhythmic guitar loops of a certain note may be able to narrow the search results to contain only rhythmic guitar loops and further define the search to find loops within one to two notes of the desired note.

This and other searching functionality is accomplished in one embodiment of the invention by utilizing a tagging technique to build an index that associates a set of audio files with a number of musically distinct classifications. When queried, a search engine utilizes this index to locate audio files that fall within the parameters of the query. A query building tool that is tightly coupled with the index is presented to the user via a Graphical User Interface. In contrast to prior art search engines which hide the index, embodiments of the present invention make a portion of the index available to the user as part of the query building tool. The query building tool constrains user inputs to match the classifications stored within the index. By effectively managing the inputs, the search engine described herein is able to return a better set of results than existing search engines. For instance, the search engine described herein is capable of locating a set of useful files by providing the user access to the keywords that are specific to the search query thus controlling the results of the search operation.

The index is built in accordance with one embodiment of the invention from information embedded into or associated with a set of audio files. Audio file formats such as WAV or AIF formats do not have an appropriate way to index the contents of a file. One aspect of the present invention provides users with a mechanism for tagging a set of audio files such as WAV or AIF files to embed information into the file the search engine may later use for purposes of locating the tagged file. This tagging process is referred to in one embodiment of the invention as file enhancement. One a file is appropriately tagged, the search engine uses the tags for later indexing.

### File Enhancement

The process of file enhancement involves assigning specific identifying information in the form of tags to a file (e.g., an audio file). For instance, users may identify the content of an audio file and thereby classify the audio file into one or more categories (e.g., property tags, search tags, and descriptors). In one embodiment of the invention, property tags define the musical properties of the audio file. Search tags, for example, provide a set of keywords that a user might use when searching for a particular type of music. And descriptors may provide information about what type of mood an audio file conveys to the audience, for example, cheerful.

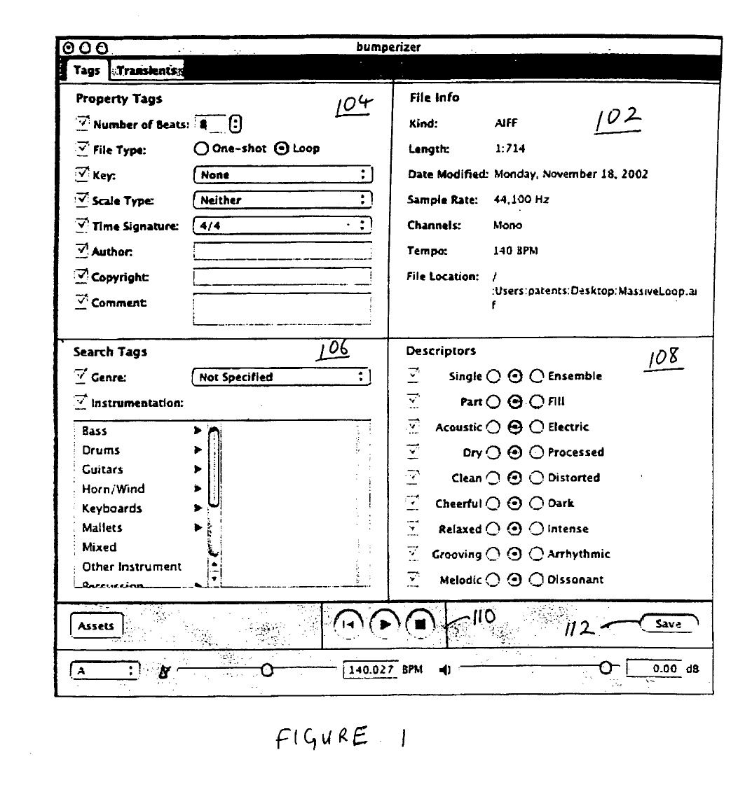

FIG. 1 is a sample user interface for assigning tags and descriptors to a loop. In one embodiment of the invention data written in the eXtensible Markup Language (XML) is what defines the tag information. Those of skill in the art will recognize that the term tag refers to any type of information about an audio file and that the term is not limited only to the examples given herein. Moreover readers should note that although the tagging of audio files is performed here via a Graphical User Interface, the invention contemplates tagging files manually, via a command line process, or using any other technique acceptable for purposes of associating the tag data with the audio file.

In this sample illustration, basic information about the file to be tagged is provided in block 102. Block 104 contains a list of sample property tags such as the number of beats, whether the audio file is a loop or one-shot, musical key, scale type, time signature, etc.

Block 106 contains sample search tags. For example, search tags may include musical genre and instrumentation. The instrumentation category may include bass, drums, guitars, horn/wind, keyboards, mallets, mixed, or any other type of instrument.

In block 108, descriptors may be assigned to the file. For instance, the audio file could have originated from a single player (i.e. soloist) or an ensemble, be part or fill, acoustic or electric, dry or processed, clear or distorted, cheerful or dark, relaxed or intense, grooving or arrhythmic, melodic or dissonant, etc.

In this illustration, controls 110 allow playback of the file while tagging. This capability enables users to tag a file while the sound and general characteristics of the audio file is still fresh in the users mind. After tagging the audio file button 112 writes the file to disk for later use.

In one embodiment of the invention, the tag information is appended to the end of the audio file without distorting the content of the audio file. By appending the tag information at the end of the audio file, the system may still read and play the tagged audio file. Thus, the tagging process does not affect playback of the file itself. Media players and other audio playback applications are still able to recognize and play the tagged file. Other embodiments of the invention append tag information in other portions of the audio file such as the header, beginning, etc. It is also feasible to store the tag information in a separate file where that separate file is associated with the audio file via an appended pointer or some other means.

Property Tags:

Audio files may contain embedded property information such as speed counts and basic type information. Although such information provides some basic characteristics about the audio file, this information is not sufficient for purposes of searching.

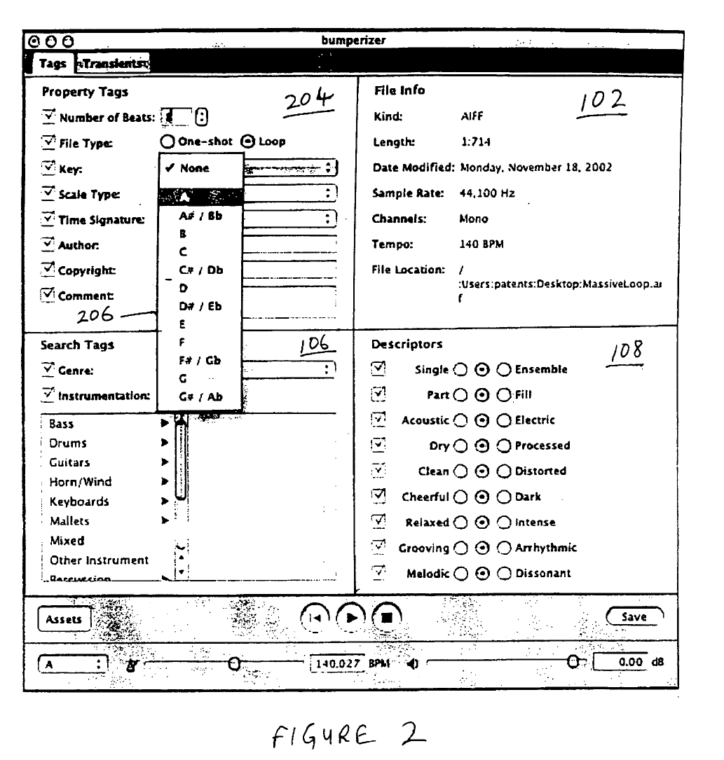

FIG. 2 illustrates an assignment of a property tag that defines the musical key of the audio file: massiveloop.aif (see block 102). The interface allows users to assign the appropriate key from a drop down menu 206 for selection from all the musical keys, e.g., A, A#/Bb, B, C, C#/Db, D, D#/Eb, E, F, F#/Gb, G, and G#/Ab.

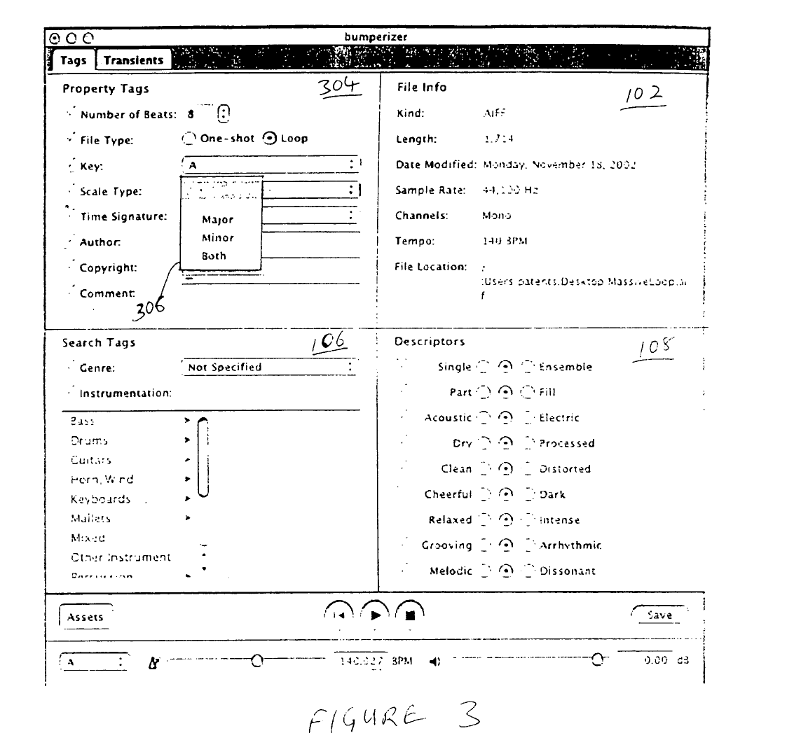

FIG. 3 illustrates an assignment of scale type to the musical key. For instance, drop down menu 306 in property tags selection block 304 allows assignment of major, minor, both major and minor, or neither major nor minor to the musical key.

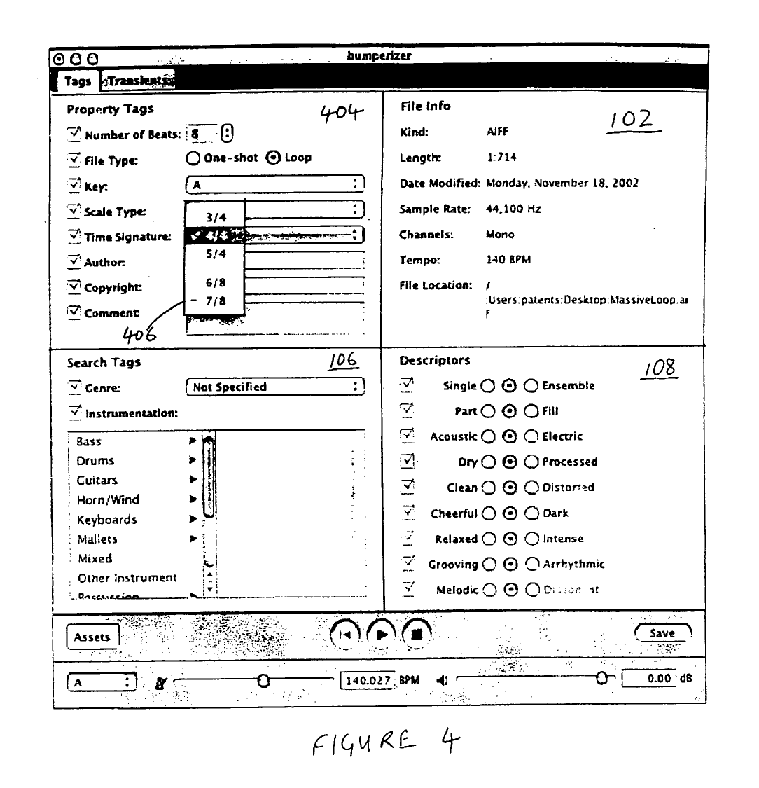

FIG. 4 illustrates the selection and assignment of time signatures to a sound file. Drop down menu 406 in property tags selection block 404 allows assignment of any one of time signatures 3/4, 4/4, 5/4, 6/8, and ⅞. The time signature is a description of the beats of the music. The numerator represents the number of beats; the denominator, the length of each beat. For example, a designation of ¾ means that the audio file has three quarter notes per measure; 6/8 denotes six-eight notes per measure; and 4/4 denotes four quarter notes per measure. 4/4 is the most common time signature.

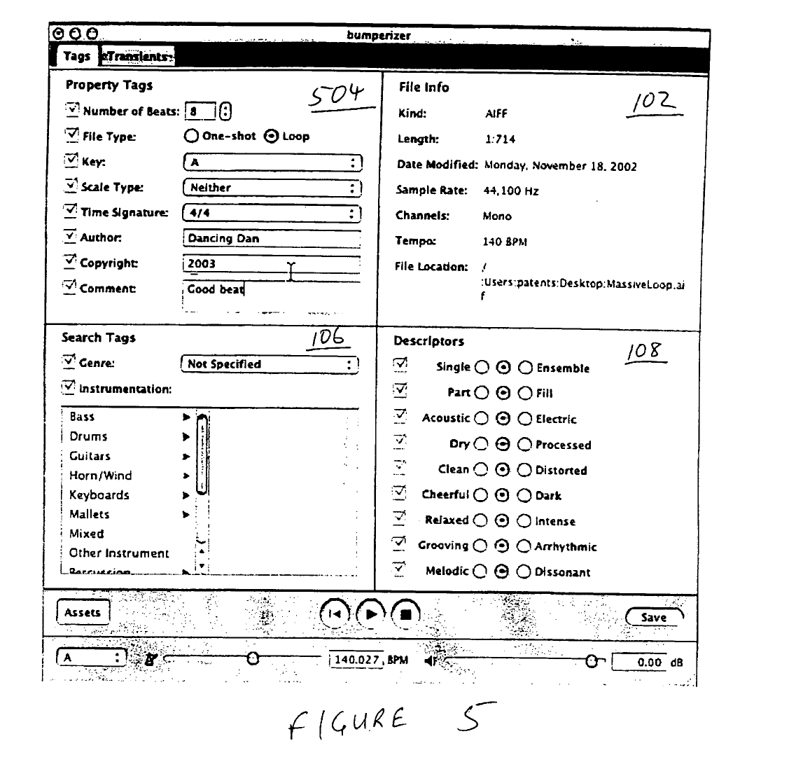

The remainder of the property tag fields, e.g., author, copyright, and comment are editorial and may be completed as shown in FIG. 5, block 504. FIG. 5 illustrates a complete set of the assignable property tags. For instance, block 504 shows that the following properties have been assigned to the file massiveloop.aif: number of beats is “8”; audio file type is “loop” instead of “one-shot”; key is “A”; scale type is “neither” major nor minor; time signature is “4/4”; author is “Dancing Dan”; copyright is “2003”; and comment is “Good beat”.

Search Tags:

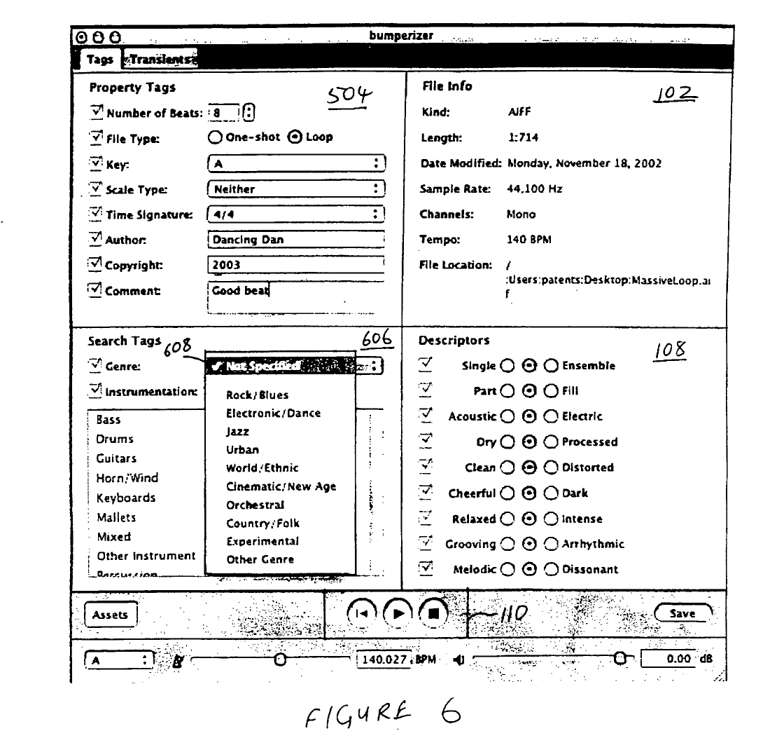

As discussed earlier, the assignment of keywords for purpose of enabling the search engine to return a narrow result is an important aspect of the invention. One embodiment of the invention utilizes a tagging technique to build an index that associates a set of audio files with a number of musically distinct classifications. FIG. 6 illustrates the assignment of a musical genre to the audio file being tagged. In search tags block 606 musical genre may be assigned using drop down menu 608. Available genre selections in drop down menu 608 may include: Rock/Blues, Electronic/Dance, Jazz, Urban, World/Ethnic, Cinematic/New Age, Orchestral, Country/Folk, Experimental, etc. Here again, a user may use controls 110 to playback the audio file in order to facilitate the proper genre selection.

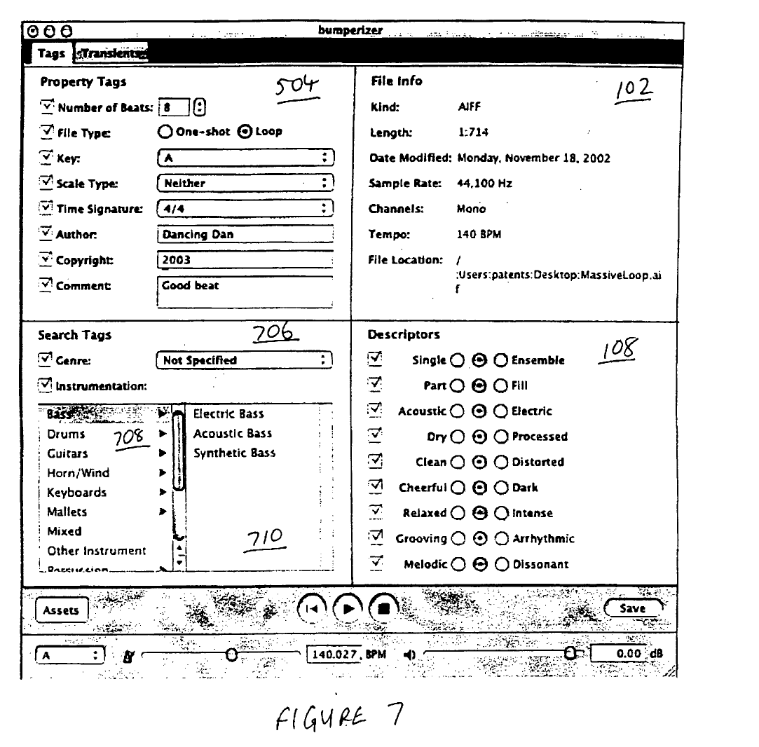

FIG. 7 illustrates how a user might define a set of these musically distinct classifications by assigning an audio file to a set of instrumentation search tags. Search tag block 706 includes instrumentation windows 708 and 710. In window 708, the type of instrument is presented and in window 710, the sub-category of the instrument is presented. For instance, if the type of instrument is bass, then the sub-categories may include electric bass, acoustic bass, and synthetic bass.

The kind of instruments in block 708 may in addition to bass, include: drums, guitars, horn/wind, keyboards, mallets, mixed, percussion, sound effects, strings, texture/vocals, and other instruments. For each category of instrument, there may be sub-categories listed in block 710.

Sub-categories of drums available for selection in block 710 may include, e.g., drum kit, electronic beats, kick, tom, snare, cymbal and hi-hat.

Sub-categories for guitars may include, e.g., electric guitar, acoustic guitar, banjo, mandolin, slide guitar, and pedal steel guitar. Sub-categories for horn/wind may include: saxophone, trumpet, flute, trombone, clarinet, French horn, tuba, oboe, harmonica, recorder, pan flute, bagpipe, and bassoon.

Sub-categories for keyboards may include: piano, electric piano, organ, clarinet, accordion and synthesizer. Sub-categories for mallets may include: steel drum, vibraphone, marimba, xylophone, kalimba, bell, and timpani.

Sub-categories of percussion may include: gong, shaker, tambourine, conga, bongo, cowbell, clave, vinyl/scratch, chime, and rattler. Sub-categories of strings may include: violin, viola, cello, harp, koto, and sitar. And finally, sub-categories of texture/vocals may include: male, female, choir, etc.

Using interface blocks 708 and 710, the user or creator may assign the appropriate category and sub-category of instrumentation, from the various choices, to the audio file.

Descriptors:

The final steps in tagging involve assigning descriptors to the audio file. Descriptors could, for instance, convey the mood/emotion which the audio file tends to trigger.

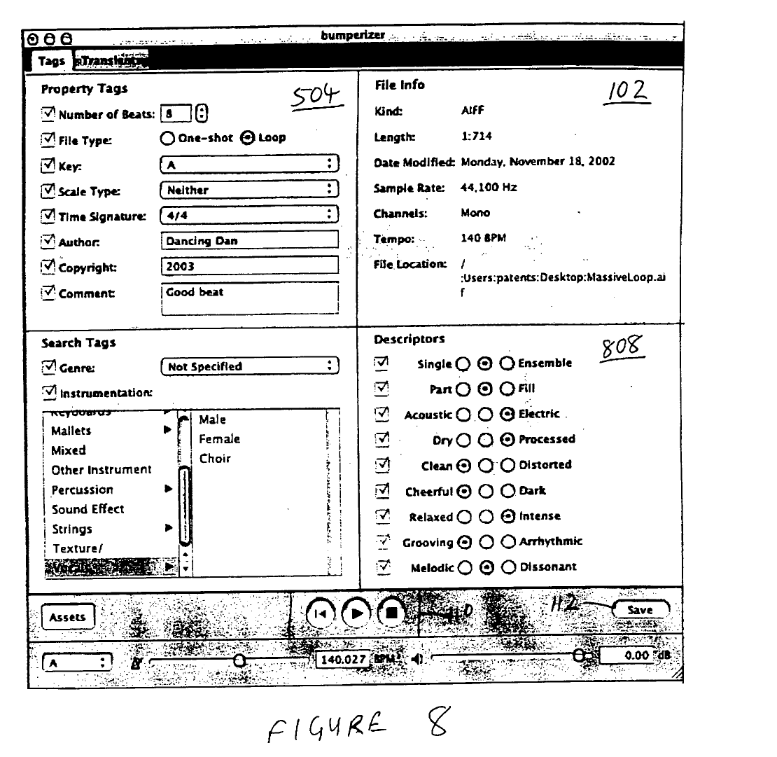

FIG. 8 is an illustration of assignment and selection of descriptors. Multiple descriptors may be assigned to the same audio file. For instance, the user may specify whether the audio file is by a single soloist or an ensemble of soloists; part or fill; acoustic or electric; dry or processed; clear or distorted; cheerful or dark; relaxed or intense; grooving or arrhythmic; and melodic or dissonant. In the illustration of FIG. 8, the audio file massiveloop.aif is assigned descriptors in block 808 corresponding to: electric, processed, clean, cheerful, intense, and grooving.

After the assignment of all the tags and descriptors, the file is then saved using button 112. Again, as discussed previously, one method of saving is to append the tags and descriptors data to the end of the audio file. The appended data could take any desired format, e.g., XML.

### Indexing

The process of indexing the tagged audio files involves collecting and collating the tag information associated with each of the audio files in order to make a usable index for the search engine. The information collected during the file enhancement process discussed above is what defines the tags associated with each audio file being indexed. Since prior art audio files have no tag information, there are two aspects to indexing.

The first aspect involves those audio file files without any human provided tag information, for example, prior art audio file files contained in CDs. In these cases, tagging may be provided either for a single file or for multiple files in a batch mode using the methods described above. For instance, batch mode tagging may be desirable if most or all of the files being tagged have common characteristics, e.g., acoustic guitar. Additional tagging for individual files may subsequently be applied after batch mode tagging to highlight the specific characteristics of each individual file. And as discussed above, these tags maintain the audio integrity of the audio file while simultaneously providing needed data to the search engine. Thus, in one embodiment of the invention, tagged files are compatible with prior art systems, but able to provide the search engine with detailed information about the contents of the audio file.

The second aspect of indexing involves collecting and collating tag information from audio file files in a directory. The indexer does this in two phases.

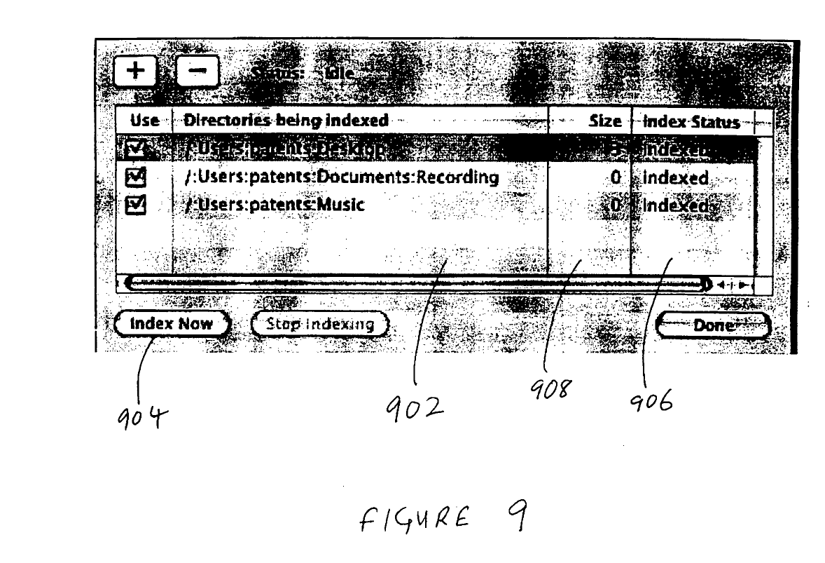

In the first phase the indexer goes through the path containing the files to be indexed and decomposes the path. The path to be indexed is provided by the user using, for example, the user interface of FIG. 9.

FIG. 9 is an illustration of a user interface for indexing audio files. The user selects the directory path to be indexed by highlighting desired directories in window 902, labeled “Directories Being Indexed” and then selecting the “Index Now” button 904. In window 906, the user is provided information as to the status of each directory. For instance, if the directory is not yet indexed, it may have no information in block 906. But if it had been indexed, then it may contain information such as “Indexed”.

In block 908, the indexer presents the number of audio files in the directory. In the illustration, the audio file directory “/:Users:patents:Desktop” contains three audio file files which were indexed.

To index a directory, the indexer tries to obtain keywords or infer keywords from the tag information provided for each file in the directory.

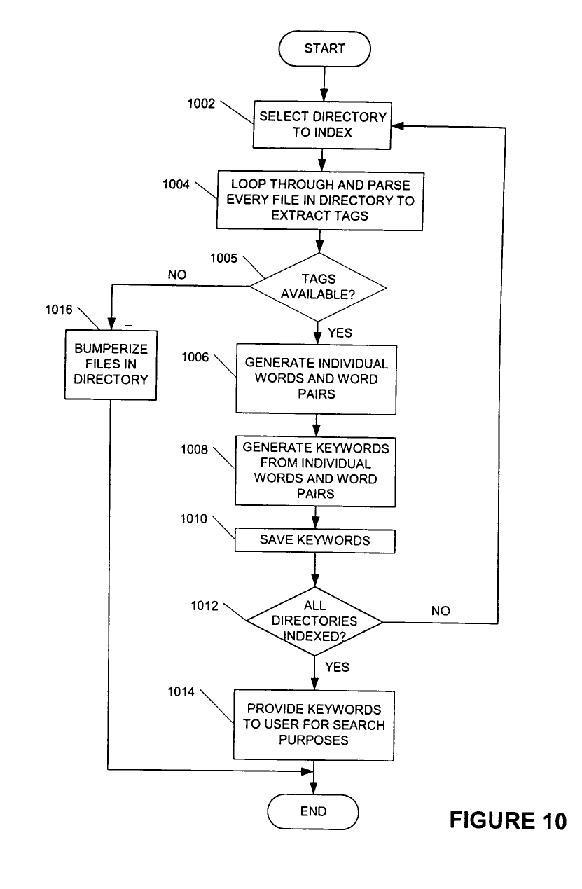

FIG. 10 is an illustration of indexing in accordance with an embodiment of the present invention. To index a directory, the user selects a directory to be indexed in step 1002. At step 1004, the indexer checks to see if there is any human based tag information in the directory path. This is basically a path decomposition phase.

During path decomposition, the indexer parses each file to obtain the human provided tag information. If there is no tag information, as determined by the check in step 1005, the files in the directory may then be enhanced (e.g., tagged) in step 1016. However, if tag data exists, at step 1006 the indexer arranges the collected tag information into individual words and various pairs of words, e.g., “rhythm guitar”, or “hip hop”. Then, at step 1008 the individual words and pairs of words are processed through a translation process, e.g., table lookup, to generate search keywords. The keywords that are not found in the translation table may be inferred using past knowledge, for example. These search keywords are then saved in step 1010.

If there are more directories to be indexed, as determined in step 1012, processing returns back to step 1002 until all the directories have been indexed. After processing, all the saved keywords from step 1010 are then loaded back into memory at step 1014 for use by the query process of the search engine.

While processing each directory during indexing, the indexer parses the audio files and generates words and pairs of words. Because the indexer may have no way of knowing where the tags came from, it may need to translate the words and pairs of words using known information. Basically, the indexer tries to infer the keywords using past knowledge. In one embodiment, the indexer runs this potentially huge list of possible keywords and word pairs through a translation dictionary that contains an extensive list of data. Thus, the translation dictionary contains a set of mappings to the tagged keywords defined via the file enhancement process discussed herein. In one embodiment of the invention, an expert user defines the translation table so that the table represents an accumulation of likely search terms and correlates these terms to the tagged keywords. The following XML listing illustrates an example set of translation table entries:

Sample Translation Table

<key>Flutes</key><string>Flute</string>
<key>Gnarled</key><string>Dark</string>
<key>Drum Machines</key><String>Electronic Beats</string>
<key>Deep Atmospherics</key><array><String>Cinematic/New
Age</ string><string>Texture/Atmosphere</string><string>Proc
essed</string></array>

In this example, the words or word pairs generated by the indexer from the tags are bracketed as follows:

+TL,9/24 <key> words or word pairs </key>

and the resulting keywords and keyword pairs are bracketed as follows:

<string> keyword or keyword pairs </string>.

Thus, the entries in the sample translation table above indicate that words like “Flutes” will translate into “Flute” and “Gnarled” will translate into “Dark”. Word pairs like “Drum Machines” will translate into “Electronic Beats”, and “Deep Atmospherics” will translate into multiple keywords such as “Cinematic/New Age”, “Texture/Atmosphere”, and “Processed”. Readers should note that the translation table shown here is for exemplary purposes only and not limited in any to the specific set of mappings described. At a conceptual level, the translation table simply represents any set of terms mapped to an exposed set of keywords. For instance, the translation engine may map a single word like chorus to ensemble. Thus, the benefit of translation is that numerous simple words, e.g., chorus, obtained from the audio file directories may be mapped to a smaller set of key words which is much more manageable in the search process.

This process may be referred to as “Search key translation” because it translates information provided in the audio files to appropriate and manageable search keys. One advantage of search key translation is that the tag information in an audio file may be in any language. And irrespective of language, the proper search results may still be obtained since the translation dictionary should contain all the possible keywords in all the languages. Thus, the translation phase involves associating tag information to a limited set of search keywords.

In an example of search key translation of the word pairs, assuming the tag information is such that the word pair is “Spanish guitar”. The translation engine may assign multiple key words to a single word pair so that, for example, “Spanish guitar” may be assigned to “acoustic guitar” and “world/ethnic”. And the translation engine will do this for every single word and pair of words as it tries its best to infer the proper keyword from the provided tag information.

Thus, the indexing phase of an embodiment of the present invention goes through and attempts to generate appropriate search keywords using the translation engine. The indexer takes a very large set of words and distills it down to a very compact set of words thereby allowing the user to do a search from a user interface that gives a precise set of matches. This is unlike prior art search engines where each word stands by itself with the exception of “a” and “the”.

A diagnostic mode may also be provided so that the search engine may inform the user when it could not find a match. The diagnostic mode may dump all the words and pairs of words that could not be processed so that the information may be included in the translation database (or table). Thus the translation table is capable of learning as things change.

### Search Interface

An embodiment of the present invention allows the user to see what is available and provides the necessary keywords to obtain the correct results when searching for a desired type of audio file. For instance, assuming a CD with 11,000 audio files, 850 of which are guitars and the user is searching for a particular type of guitar. The user can simply enter “guitar” and the search engine will compare the input against 11,000 audio files and return for 850 audio files.

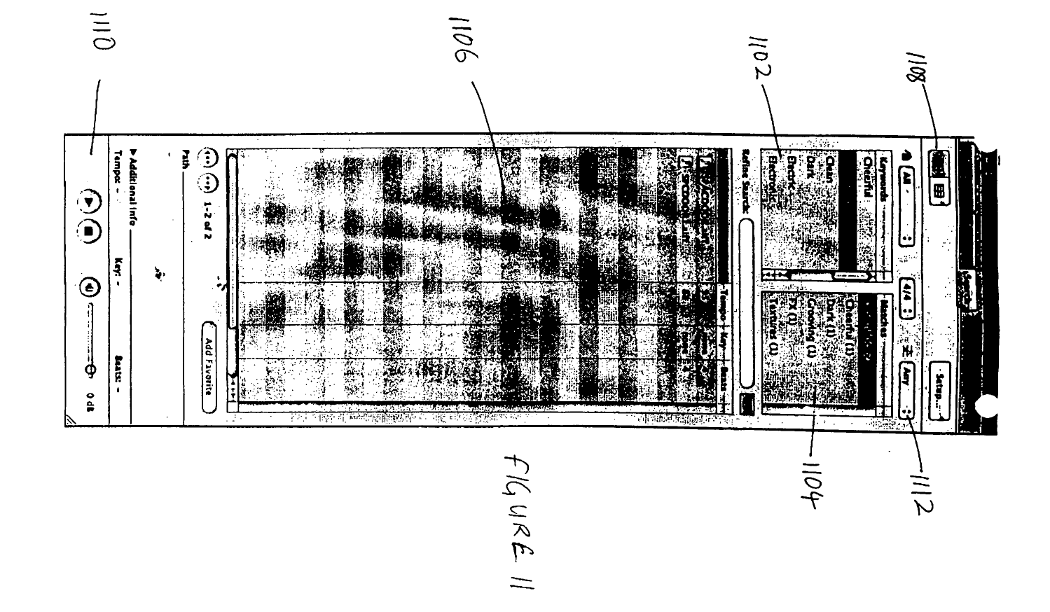

However, after the indexing phase, an embodiment of the present invention presents the user with the appropriate keywords in the form of a selection menu. FIG. 11 is an illustration of a search engine interface in accordance with an embodiment of the present invention. The indexing phase discussed above parses the set of audio files in each directory path to obtain tag information which is then distilled down to a set of key words. The indexer builds a large data structure for each directory and saves it. All the data structures generated are subsequently processed through the translation process discussed above and the limited set of keywords found is used to populate menu block 1102. Note that keywords not found will not appear in menu block 1102. Therefore, block 1102 may not contain the entire set of search engine keywords, just the limited set of key words that were exposed as part of the indexing process. Thus, the indexer does not list words for which there are no matches.

This is unlike conventional search engines which allow users to submit any set of keywords, even those that return an overly broad set of matches. Thus, in embodiments of the present invention, certain keywords are exposed to the user. Prior art search engines do not expose aspects of the index and thus users must type in a query and arrange words such as by placing them within quotes or try to guess how the search is indexed in attempts to get a high quality match.

Embodiments of the invention are unlike prior art search engines in that the user is only provided keywords that are already associated with audio files. Thus, the user may select the appropriate keyword to refine the search results. For instance, assuming a keyword search that produces forty-seven organs, forty-six of which are in the general category, and one of which is an “intense organ”. A user looking for more than an organ need not wonder whether there is an “intense organ” for example because the user interface will clearly show that there is an intense organ. If the user desires the intense organ, they can simply click on it and the file name will appear on block 1106. The indexer provides the user information about all the tagged files so that there is not guessing while searching for a desired audio file.

In the illustration of FIG. 11, the keywords found in the indexed files include “Cheerful”, “Cinematic”, “Clean”, “Dark”, “Electric”, “and “Electronic”. The matches are shown in block 1104 as follows: two files match the “Cinematic” keyword, one file is “Cheerful”, one file is “Dark”, one file is “Grooving”, one file is “FX”, and one file is “Textured”. Thus if the user desires “Cinematic” genre, the user selects the keyword “Cinematic” from menu block 1102. Menu block 1104 may be used to refine the search and thus narrow the match results. In block 1106, the two “Cinematic” files are presented to the user. The user may then play the audio file using control buttons 1110. Thus, the user need only listen to those audio files that within some limit of what the project requires.

A user wants to preview audio files to determine appropriate ones for the particular project. The user may not want to preview several hundred drums, for example. Thus an embodiment of the present invention provides a tone limiting feature. The tone limiting feature uses the project key, e.g., A, and only return audio files which are within a desired number of semitones, e.g., two semitones of the project key. For instance, two semitones from A is A sharp (A#) and B and then also G sharp (G#) and G. This capability further narrows the search from the search engine. Thus, if a normal search will produce over a thousand horns, for example. Activating the tone limiting feature provides the user only those audio files which are close to the project key so the user does not have preview audio files that are so far off to fit in the project. Thus, the tone limiting feature further reduces the set of audio files to give a tight search result.

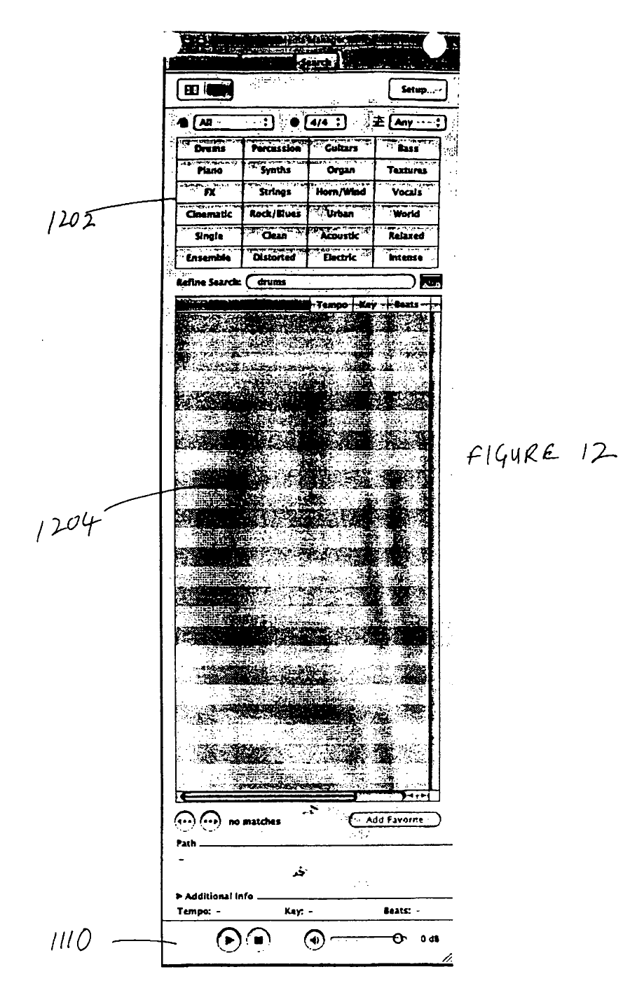

Another embodiment of the present invention provides the user preprogrammed selectable buttons. The button view is shown in FIG. 12. Unlike the column view of FIG. 11 which allows you to do complex searches by organizing every single keyword in a column for the user, the button view provides a very limited set of keywords. For example, the button labels in block 1202 include: Drums, Percussion, Guitars, Bass, Piano, Synths (i.e., synthesizer), Organ, Textures, FX, strings, Hom/Wind, Vocals, Cinematic, Rock/Blues, Urban, World, Single, Clean, Acoustic, Relaxed, Ensemble, Distorted, Electric, and Intense.

This capability allows the simple user who just desires drums to click on “Drums” and all the drums will instantly appear in block 1204. The user does not have to scroll through a list of keywords in this mode. Other embodiments of the present invention provide the ability to perform an “and” and an “or” search. An “and” search provides an intersection of the keywords. The “or” search provides results to match all the selected keywords.

Thus, a method and apparatus for locating useful sound files have been described. Particular embodiments described herein are illustrative only and should not limit the present invention thereby. The invention is defined by the claims and their full scope of equivalents.

What is claimed is:

1. A method for locating useful sound files comprising:
specifying a directory having a plurality of sound files;
parsing each of said plurality of sound files to extract tag information;
generating one or more words and word pairs from said tag information;
generating one or more keywords from said one or more words and word pairs; and
providing said one or more keywords to a user for use as query in searching for a desired sound file for a project.

2. The method of claim 1, wherein said directory is a network path.

3. The method of claim 1, wherein said directory is the World-Wide-Web.

4. The method of claim 1, wherein said directory is a computer storage media.

5. The method of claim 1, wherein said each of said plurality of sound files has tag information appended to an audio content.

6. The method of claim 1, wherein said each of said plurality of sound files has an associated tag information.

7. The method of claim 1, wherein said tag information comprises property tags.

8. The method of claim 1, wherein said tag information comprises search tags.

9. The method of claim 1, wherein said tag information comprises descriptors.

10. The method of claim 1, wherein said searching for a desired sound file produces a second plurality of sound files.

11. The method of claim 10, wherein each of said second plurality of sound files is within a predefined number of semitones of said project.

12. The method of claim 1, wherein said generating one or more keywords comprises running said one or more words and word pairs through a translation process.

13. The method of claim 12, wherein said translation process comprises equating said one or more words and word pairs with at least one keyword.

14. The method of claim 13, wherein said equating comprises a translation table lookup.

15. An apparatus for locating useful sound files on a computer system comprising:
a first graphical user interface on a computer system for specifying a directory having a plurality of sound files;
an indexer on said computer system parsing each of said plurality of sound files to extract tag information, said indexer generating one or more words and word pairs from said tag information;
a translator associated with said indexer for generating one or more keywords from said one or more words and word pairs; and
said indexer providing said one or more keywords at a second graphical user interface for use as query in searching for a desired sound file for a project.

16. The apparatus of claim 15, wherein said directory is a network path.

17. The apparatus of claim 15, wherein said directory is the World-Wide-Web.

18. The apparatus of claim 15, wherein said directory is a computer storage media.

19. The apparatus of claim 15, wherein said each of said plurality of sound files has tag information appended to an audio content.

20. The apparatus of claim 15, wherein said each of said plurality of sound files has an associated tag information.

21. The apparatus of claim 15, wherein said tag information comprises property tags.

22. The apparatus of claim 15, wherein said tag information comprises search tags.

23. The apparatus of claim 15, wherein said tag information comprises descriptors.

24. The apparatus of claim 15, wherein said searching for a desired sound file produces a second plurality of sound files.

25. The apparatus of claim 24, wherein each of said second plurality of sound files is within a predefined number of semitones of said project.

26. The apparatus of claim 15, wherein said generating one or more keywords comprises said translator running said one or more words and word pairs through a translation process.

27. The apparatus of claim 26, wherein said translation process comprises equating said one or more words and word pairs with at least one keyword.

28. The apparatus of claim 27, wherein said equating comprises a translation table lookup.
